(19) United States
(12) Patent Application Publication
(10) Pub. No.: US 2007/0143792 A1
(43) Pub. Date: Jun. 21, 2007

(54) Extensible Mechanism For Storage And Interchange Of Objects

(75) Inventors: Colin L. Acton, Kirkland, WA (US); Frederic Azera, Redmond, WA (US); Constantin Stanciu, Redmond, WA (US); Samuel D. Clement, Redmond, WA (US); Stephen R. Husak, Redmond, WA (US); Alan E. Shield, Issaquah, WA (US); Andrew M. Simms, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,807

(22) Filed: Jan. 30, 2006

Related U.S. Application Data
(60) Provisional application No. 60/743,048, filed on Dec. 16, 2005.

(51) Int. Cl. H04N 5/445; G06F 3/00; G06F 13/00

(52) U.S. Cl. 725/39; 725/50

(57) ABSTRACT

An extensible mechanism for storage and interchange of objects is described herein. According to first aspect of the disclosure, objects having respective class definitions are received. The objects are represented in an interchange format by mapping the class definitions of the objects to corresponding fields defined within the interchange format. According to a second aspect of the disclosure, the objects are loaded into a persistent store by mapping the class definitions of the objects to corresponding fields of the store. According to at least a third aspect of the disclosure, a data structure for a unique identifier element is described, along with processes using the unique identifier element to determine whether to update an existing object in the store, or to create a new object in the store.

### CROSS-REFERENCE TO RELATED APPLICATIONS

This applicant claims the benefit of the filing date of U.S. Provisional Application Ser. No. 60/743,048, filed on 16 Dec. 2005, to the fullest extent permitted under 35 U.S.C. §19(e). The subject matter contained in the foregoing Provisional Application is incorporated herein by this reference as if set forth verbatim herein.

### BACKGROUND

Personal computers (PCs) are increasingly used to display various types or instances of media, such as movies, television broadcasts, sporting events, or the like. As more of these different instances of media become available, it becomes a challenge to organize the media for convenient presentation to the viewer or user. For example, data representing a variety of different TV shows may be arranged into an interactive guide, so that the viewer can see which shows are being shown when, and on which channels.

Typically, the data used to populate such interactive guides, or other such user or viewer interfaces, are stored according to a relatively rigid specification. For example, a listing for a given TV show might be defined to contain data for a showing time, duration, episode synopsis, or the like. The specification would then dictate how the underlying data is stored. Thus, any software and systems related to presenting the guides or the media on the PC may be implemented based on this specification. When new types of data relating to the guides become available, the specification may be updated. However, any updates to the specification may result in a ripple effect, causing related updates to the software and systems.

### SUMMARY

An extensible mechanism for storage and interchange of objects is described herein. According to first aspect of the disclosure, objects having respective class definitions are received. The objects are represented in an interchange format by mapping the class definitions of the objects to corresponding fields defined within the interchange format. According to a second aspect of the disclosure, the objects are loaded into a persistent store by mapping the class definitions of the objects to corresponding fields of the store. According to at least a third aspect of the disclosure, a data structure for a unique identifier element is described, along with processes using the unique identifier element to determine whether to update an existing object in the store, or to create a new object in the store.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The same numbers are used throughout the disclosure and figures to reference like components and features. The leftmost digit of the reference numbers indicate the drawing figure in which this reference number is introduced.

FIG. 1 is a block diagram of an operating environment for an extensible mechanism for storage and interchange of objects.

FIG. 2 is a block diagram of various non- examples of data sources as shown in FIG. 1.

FIG. 3 is a block diagram of an operating environment including an example application as shown in FIG. 1.

FIG. 4 is a combined block and flow diagram of several objects as they may be stored in an object store, and of a related process for performing garbage collection on an object store containing the objects.

FIG. 5 is a block diagram of an operating environment containing components with which the applications may operate.

FIG. 6 is a combined block and flow diagram of a data flow as shown in FIG. 1, broken into a stream incoming to the object store and a stream outgoing from the object store, along with related processing components.

FIG. 7 is a flow diagram of a process flow for correlating data in an incoming MXF stream with objects that already exist in the object store.

### DETAILED DESCRIPTION

Overview

The following document describes system(s) and/or method(s) (“tools”) capable of many techniques and processes. The following discussion describes exemplary ways in which the tools provide an extensible mechanism for storage and interchange of objects. This discussion also describes ways in which the tools perform other techniques as well.

Operating Environment

Before describing the tools in detail, the following discussion of an exemplary operating environment is provided to assist the reader in understanding one way in which various aspects of the tools may be employed. The environment described below constitutes but one example and is not intended to limit application of the tools to any one particular operating environment. Other environments may be used without departing from the spirit and scope of the claimed subject matter.

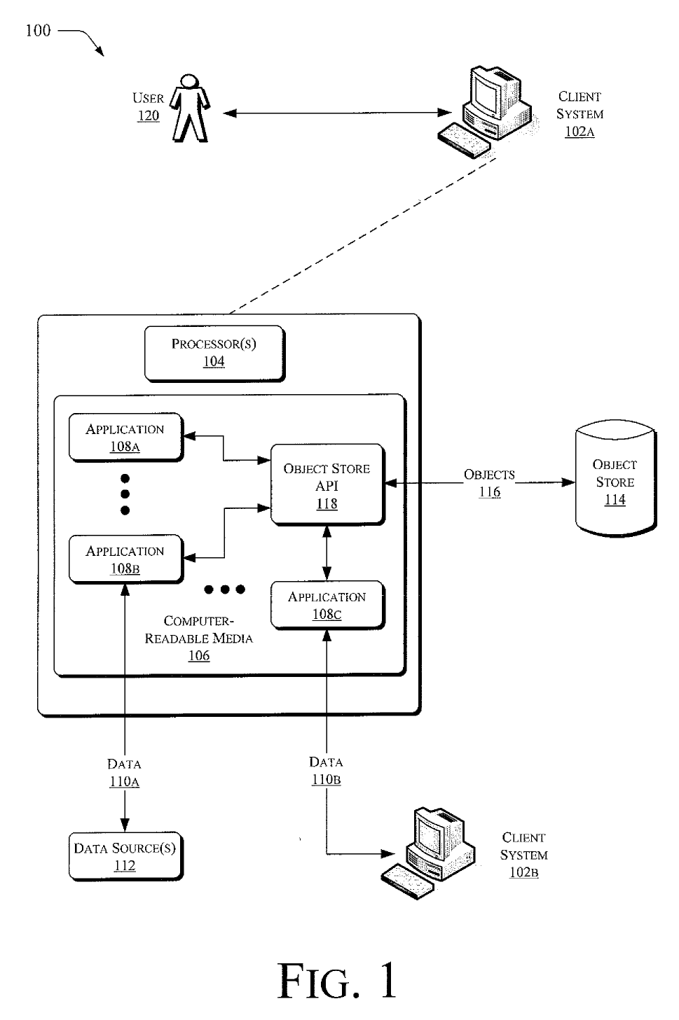

FIG. 1 illustrates one such operating environment for an extensible mechanism for storage and interchange of objects, generally at 100. The operating environment 100 can comprise one or more client systems 102 having one or more processor(s) 104 and computer-readable media 106. For convenience only, FIG. I shows two client systems 102a and 102b, although any number of client systems 102 may be included in various implementations of the operating environment 100. While the components of the client system 102a are described in detail, it is understood that this description applies equally to the client system 102b, or, more generally, to other client systems 102.

Instances of the client systems 102 can comprise a computing device, such as a cell phone, desktop computer, personal digital assistant, server, or the like. The processor 104 can be configured to access and/or execute the computer-readable media 106. The computer-readable media 106 can comprise or have access to one or more applications 108, which may be implemented as a module, program, or other entity capable of interacting with a network-enabled entity. At least one of the applications 108a may take the form of a media player application such as, for example, the Media Center™ application available from Microsoft Corporation of Redmond, Wash. The Media Center™ application or similar application 108a enables the client system 102 to function similarly to a television set, and can include digital recording capability, among other functions.

An application 108b may take the form of an application that functions to send and/or receive data 110a from one or more data sources 112 for storage in an object store 114. For convenience, but not limitation, the application 108b may be considered a “loader” application in this description. However, it is understood that the data flow 110a may be bi-directional in nature, as shown by the double-headed arrow representing the data flow 110a in FIG. 1.

An application 108c may transmit or receive a data stream 110b to and/or from one or more client systems 102b. For convenience only, but not limitation, such an application 108c may be considered an “extractor” application in this description. As detailed further below, the extractor application 108c can retrieve data from the object store 114, and transmit a data stream 110b representing those objects 116 to the client system 102b. However, it is understood that the data flow 110b may be bi-directional in nature, as shown by the double-headed arrow representing the data flow 110b in FIG. 1.

The data in the streams 110a and 110b may be loaded into or extracted from the object store 114. Data loaded into or extracted from the object store 114 may take the form of objects 116. The objects 116 may be defined, instantiated, and/or transmitted according to an interchange format as described herein. The interchange format may also be used to format the data as contained in the streams 110 as communicated to and/or from the data sources 112 and client system 102b.

Data contained in the streams 110a and 110b passes through an interface 118 on its way to and/or from the object store 114. The interface 118 can take the form of an object store application program interface (API) 118. The object store API 118 serves to abstract the object store 114 from the applications 108, relieving the applications 108 from having to know the details of how the object store 114 is implemented. The object store API 118 may also format or otherwise transform the objects 116 and/or the data streams 110 according to the interchange format described herein. Additionally, the object store 114 and related object store API 118 are extensible in nature, and not governed by a rigid specification. In this manner, the object store 114 and related object store API 118 can readily adapt to accommodate data 110 of any form or format according to the interchange format. These features of the interchange format are described in further detail below.

Without loss of generality, the data streams 110 can represent information relating to various types of television programming that may be presented to a user 120 via the client systems 102. The data 110 may be stored as objects 116 in the object store 114, and thereafter used to populate an electronic programming guide (EPG) or other such user interface that may be presented to the user 120. In turn, the user 120 may interact with the client systems 102 so as to operate the applications 108.

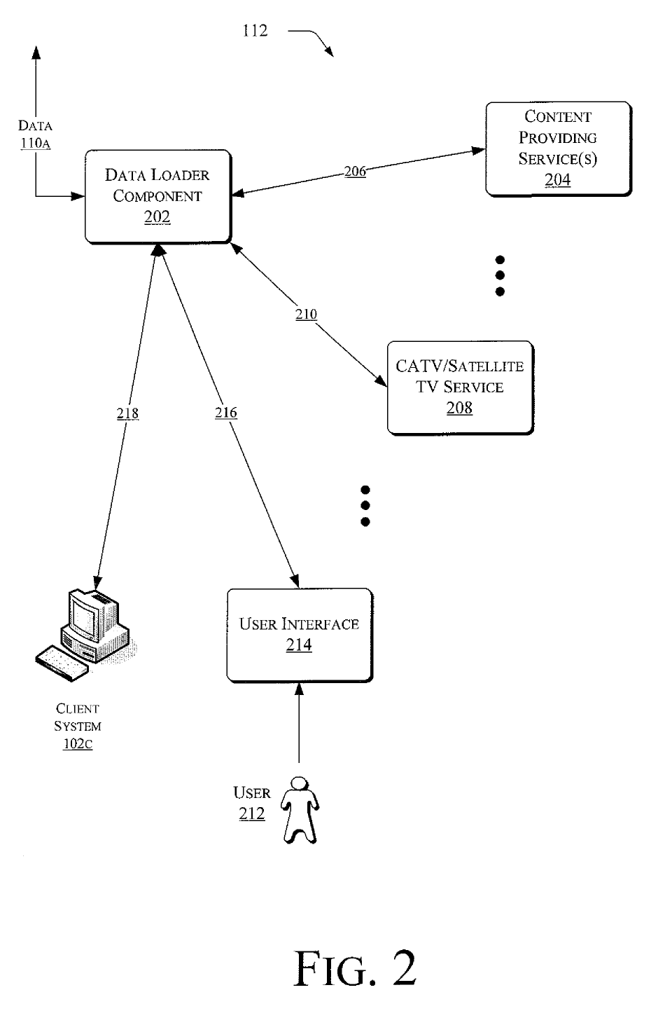

FIG. 2 illustrates various non-limiting examples of the data sources 112 shown in FIG. 1. An instance of the applications 108 shown in FIG. 1 can include a data loader component 202 that couples the client system 102 to the sources 112. The data loader component 202 is operative to receive the data from the various sources 112. In but one possible implementation, the data loader component 202 can forward this data to, for example, the loader application 108b, as data stream 110a. Illustrative contents and interchange formats for the data 110 are described in further detail below.

The data sources 112 may take a variety of forms. In some instances, the data sources 112 could include one or more content providing services 204 that are accessible over a wide area network, such as the Internet (not shown). A non-limiting and illustrative example of the content providing services 204 is the Windows Metadata and Internet Services (WMTS) service, which is available from Microsoft Corporation of Redmond, Wash. The content providing services 204 may be associated with one or more servers that store the relevant programming information, and provide it upon request. Data provided by the content providing services 204 is represented generally in FIG. 2 by the line 206.

In addition, the data sources 112 can include one or more cable or satellite television services 208 that include information relating to program content in-band within their signal transmissions. This in-band information is represented generally in FIG. 2 by the line 210.

Other examples of the data sources 112 may include users 212, who may know about local or regional programming that is typically not known outside a given locale or region. It is understood that the user 212 shown in FIG. 2 may or may not be the same user 118 as shown in FIG. 1. In some implementations, the user 212 may modulate a camera onto a given channel, and wish to provide information relating to this channel to the applications 108. In other implementations, a college or other such institution may establish a broadcast channel transmitted within a campus or other such territory. In such implementations, the user 212 may be an administrator, official, student, or other person associated with the institution. In any event, such users 212 may provide such programming information via a user interface (UT) 214. Data provided by the users 212 is represented generally in FIG. 2 by the line 216.

The data sources 112 can also include one or more other client systems, represented in FIG. 2 by the client system 102c. For example, on the client system 102c, objects 116 may be extracted from an object store 114 by an extractor application 108c, and sent to the client system 102a as a data stream 218.

It is understood that the sources 204, 208, 212, and 102c are included in FIG. 2 only for illustration, and not for limitation. More particularly, it is understood that implementations of the operating environment 100 may include other sources without departing from the spirit and scope of the subject matter described herein.

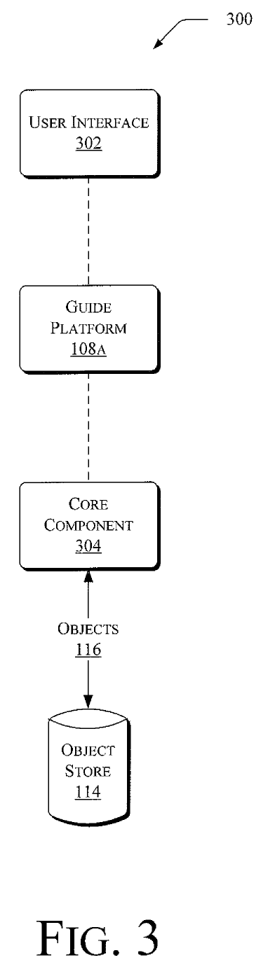

FIG. 3 illustrates an operating environment 300 including the example application 108a as shown in FIG. 1. For convenience, but not limitation, the application 108a is carried forward from FIG. 1, and can take the form of a viewer guide platform 108a. The viewer guide platform 108a presents a user interface 302 to the user 120. This viewer guide platform 108a provides a layer beneath the user interface 302. In but one example implementation, the user interface 302 presents an electronic programming guide (EPG) to the user 120. This EPG can be populated and/or driven by the viewer guide platform 108a. The viewer guide platform 108a can facilitate download and maintenance of, for example, TV channels and listings data from data sources 112 (e.g., WMIS). Recall that examples of such data sources 112 were shown and discussed in FIG. 2. The viewer guide platform 108a can also provide this data for access by the various internal and external components described herein.

The viewer guide platform 108a can be built upon a core component 304 that enables objects 116 to be easily persisted to and retrieved from the object store 114. The core component 304 leverages the capabilities of the object store 114, and provides rich mechanisms for finding the desired information as represented in the objects 116.

Descriptions of object-based implementations are provided herein only as examples, and do not limit possible implementations of the subject matter described herein. Thus, it is understood that the subject matter described herein may be implemented in a non-object context without departing from the spirit and scope of the subject matter described herein.

In the operating environment 300, the database-specific code can be isolated to ensure minimal impact to the overall operating environment 100 if any underlying database technology is altered. This isolation enables developers of the various components described herein to readily try different databases, for example, to implement the object store 114. This isolation can also maximize performance and reliability. Database-specific details thus do not trickle into the core component 304, and hence are not reflected throughout the client code that implements the guide platform 108a or other applications 108.

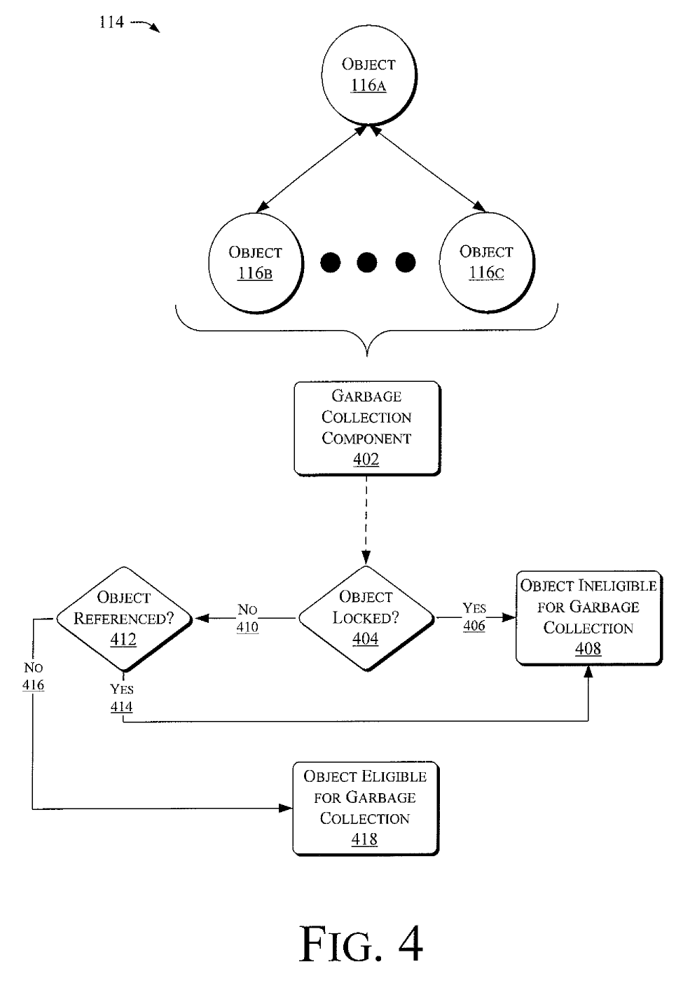

FIG. 4 illustrates several objects 116 as they may be stored in the object store 114. Three example objects 116a, 116b, and 116c are shown, with the object 116a shown as referencing or linking to the objects 116b and 116c. The objects 116 can be stored in the EPG, and can be derived from a base class labeled herein, for convenience only, as StoredObject. This base class StoredObject handles the details of moving the data in and out of the store 114. Any field that is persisted in any class derived from StoredObject can be marked with one or more attributes labeled herein, for convenience only, as a Stored attribute. Objects 116 defined in this manner can be retrieved through a collection class that is derived from StoredObject<TElement>

The following example of the StoredObject class is illustrative but non-limiting, and is presented only for to facilitate understanding of an example implementation of the EPG as described herein.

```
class Program : StoredObject
      {
      [Stored] string title;
      [Stored] string episodeTitle;
      [Stored] string description;
      [Stored] Attrs attrs;
      [Stored] Genres genres;
      [Backpointer] ScheduleEntries scheduleEntries;
      }
class Service : StoredObject
      {
      [Stored] TuneRequest tunerequest;
      [Stored] string name;
      [Stored] Network network;
      }
class ScheduleEntry : StoredObject
      {
      [Stored] Program program;
      [Stored] Service service;
      [Stored] DateTime startTime;
      [Stored] DateTime endTime;
      [Stored] Attrs attrs;
      }
```

In the above example of class definition, an object 116 in the form of a Program object can be instantiated for a given program that is represented in the EPG. The Program object can store data representing a program title, an episode title, a description, other attributes, and a genre in which the program fits. The Program object can also include one or more backpointers, which provide links or pointers to entries in the EPG in which the Program object appears.

An object 116 can also take the form of a Service object that defines a set of services available for other objects 116. In the above example, a Service object can include a TuneRequest, a string providing a name of the service, and a Network.

An object 116 can also take the form of a ScheduleEntry object. For example, the EPG can contain a ScheduleEntry object for each program that is schedule to be presented at a given time. In the above example, the ScheduleEntry object can include a reference to a Program object, a Service object, a time at which the given program starts, a time at which the given program ends, and one or more other attributes associated with the given program.

Garbage Collection

A garbage collector component 402 can operate on the objects 116 in the object store 114. The garbage collector component 402 can purge expired or unused objects 116 on an on-going basis, so that the store 114 does not become bloated with orphaned or unnecessary data. In some implementations, data is not explicitly deleted from the store 114 until such data qualifies for garbage collection. Thus, applications 108, objects 116, or other components can rely on data remaining in the store 114 as long as such data is still referenced.

The following rules can be implemented by the garbage collector component 402:
Objects 116 that are unreachable can be removed.
Root objects 116a or other objects 116b or 116c can be marked as reachable (and thus “invisible” to the garbage collector component 402) by “locking” them. Such objects 116 can remain reachable until they are unlocked. This lock feature can be implemented as a lock count for the object 116. The lock count for an object 116 can be incremented by a Lock( ) service and decremented by an Unlock( ) service. An equal number of Lock)/Unlock( ) calls can be made to unlock an object 116.
A non-weak reference from a reachable object 116a to another object 116b makes the referenced object 116b reachable.
The lifetime of an object 116a can be “tied” to the lifetime of one or more of the objects 116b or 116c that it references. In this case, the referencing object 116a is not removed as long as the referenced object 116b or 116c is still alive. This feature can be useful for extending objects 116b or 116c that are defined by some other component (e.g., the object 116a). For example, one could add his or her own ratings to a Program object (e.g., 116a) by defining a new class object (e.g., 116b or 116c) that has a “weak, tied” reference to the Program object 116a. Instances of this new class (e.g., 306b or 306c) would not be removed until the Program object (e.g., 306a) is removed.
Any object that is currently loaded into any process is considered reachable, and is not garbage collected. This can be implemented using shared memory. As objects come and go, a reference count associated with the object's id is incremented or decremented appropriately.

The foregoing rules are illustrated by process blocks 404-410. While the blocks 404-410 are described in connection with the garbage collector component 402, it is understood that other components could perform some or all of the blocks 404-410 without departing from the spirit and scope of the subject matter described herein. It is also understood that the blocks 404-410 could be performed in orders other than the order shown in FIG. 4 without departing from the spirit and scope of the subject matter described herein.

Block 404 represents determining whether a given object 116 is locked. If so, the process takes a Yes branch 406 to block 408, where the object 116 is marked as ineligible for garbage collection. Returning to block 404, if the object 116 is not locked, the process takes a No branch 410 to block 412.

Block 412 represents determining whether a given object 116 is referenced by another object 116. If so, the process takes a Yes branch 414 to block 408. Recall that in block 408, the object 116 is marked as ineligible for garbage collection. Returning to block 412, if the object 116 is not referenced, the process takes a No branch 416 to block 418, where the object 116 is marked as eligible for garbage collection.

In due course, the garbage collector component 402 traverses the store 114, identifies objects 116 marked as eligible for garbage collection, deallocates resources assigned to these objects 116, and makes those resources available for allocation to other objects 116.

Loader applications 108b can assume responsibility for controlling the lifetime of the objects 116 that they create, either by ensuring that there are references to those objects 116, or by locking and unlocking them as appropriate. For example, a loader application 108b in the form of a standard WMMS guide data loader can create objects 116 in the form of ScheduleEntry objects 116. The WMIS guide data loader can lock the ScheduleEntry objects 116 for as long as they are needed, if no other objects 116 reference the ScheduleEntry objects 116 or corresponding schedule entries. When the ScheduleEntry objects 116 or corresponding schedule entries are no longer needed (e.g., they are older than two weeks), the loader 108b can unlock them and make them available for deletion by the garbage collector component 402.

Other attributes that may be used in defining and instantiating the objects 306 are now described.

Stored Attribute

The Stored attribute is used to specify what fields are persisted in classes that derive from StoredObject. The StoredObject base class uses reflection to find these fields and to ensure that it is initialized from the store, and that any changes are reflected back into the store when the object's Update( ) method is called.

The exact behavior for fields marked with the Stored attribute depends on the field type. For example:

```
Class M : StoredObject
      {
      // string/numeric/date/time values stored for each instance.
      // Illustrative value types:
      // String, Int32, Boolean, Double, DateTime, byte [ ]
      [Stored] String sVal;
      [Stored] Int32 iVal;
      [Stored] Boolean fVal;
      [Stored] Double rVal;
      [Stored] DateTime dtVal;
      // Binary blobs -
      [Stored] byte [ ] rgb;
      }
Class N : StoredObject
      {
      // “m” is a reference to an M object
      [Stored] M m;
      // “ms” references a collection of M objects associated with this
      object
      [Stored] Ms ms;
      }
```

Stored<T> Parameterized Type

The Stored<T> type is an alternative to the Stored attribute. Fields declared as Stored<T> are not automatically loaded when an instance of the containing class is created. The choice between using the Stored<T> type and the Stored attribute is a performance and ease of use tradeoff. If the field value is used, then there is no reason to incur the overhead of creating the intermediate object, so the field can be declared with the Stored attribute. If there is a significant performance issue with always loading a particular field (e.g. it is large and seldom referenced), then it may be best to use the Stored<T> type. For example:

```
Class Stored
      {
      protected Boolean wasLoaded = false;
      protected Boolean wasModified = false;
      // binding and rawData are used to retrieve the field value at a
      later time.
      protected FieldBinding binding;
      protected Object rawData;
      protected Stored( )
            {
            this.binding = null;
            this.rawData = null;
            }
      protected Stored(FieldBinding binding, Object rawData)
            {
            this.binding = binding;
            this.rawData = rawData;
            }
      }
Class Stored<T> : Stored
      {
      protected T value;
      public Stored(T value)
            {
            this.value = value;
            this.wasLoaded = true;
            }
      public Stored(FieldBinding binding, Object rawData)
            : base(binding, rawData)
            {
            }
      public T Value {get; set;}
      }
class A : StoredObject
      {
      Stored<String> Title;
      Stored<Service> Service;
      }
```

Keyword Attribute

Fields marked with the Keyword attribute can be searched by keyword. The Stored attribute can be associated with any field marked as Keyword. When a Keyword field is modified, entries are automatically entered in a keyword table associated with the field. Later, a WhereFieldContainsKeyword query can be performed to find all the items with the specified keywords. Weak and Tied Attributes

A field marked as Weak indicates that the reference should not effect the lifetime of a referenced object (e.g., the objects 116b or 116c shown in FIG. 4). If no other objects (e.g., the object 116a shown in FIG. 4) are referencing the referenced object 116b or 116c, then the referenced object 116b or 116c is free to be garbage collected. If and when the referenced object 116b or 116c is garbage collected, the weak reference becomes null.

A field marked as Tied indicates that the lifetime of the referencing object 116a is tied to the lifetime of the object 116b or 116c being referenced. The referencing object 116a is not be garbage collected as long as the referenced object 116b or 116c has not yet been garbage collected. For example:

```
Class MyRating : StoredObject
      {
      [Stored, Weak, Tied] Program program;
      }
```

In this example, the MyRating object is not garbage collected as long as the corresponding Program object has any references, because of the Tied attribute. Further, the reference to the Program object in the Myllating object does not influence the lifetime of the program, because of the Weak attribute.

Note: Specifying Tied without Weak can result in a reference cycle that can only be broken by setting Program to null. However, this is no different than two objects explicitly referencing each other.

Backpointer Attribute

The Backpointer attribute indicates that the field refers to one or more objects 116 that reference the object containing the field. For example:

```
Class X : StoredObject
      {
      [Stored] string sVal;
      [Stored] Z z;
      }
Class Y : StoredObject
      {
      [Stored] Z z1;
      [Stored] Z z2;
      }
Class Z : StoredObject
      {
      // x is set to the first X where x.z == this
      [Backpointer] X x;
      // xs is set to the collection of all X's where x.z == this
      [Backpointer] Xs xs;
      // y is set to the first Y where y.z1 == this
      [Backpointer(“z1”)] Y y;
      // o is set to the first Y where y.z2 == this
      [Backpointer(typeof(Y), “z2”)] StoredObject o;
      }
```

z.x is the same as (new X(guide))WhereFieldCompare(“z”, z)[0];
z.xs is the same as (new X(guide)).WhereFieldCompare(“z”, z)
   Class UId

The UId class associates any number of unique identifiers with any stored objects 116.

```
Class UId : StoredObject
      {
      // TargetObject is the stored object that is uniquely identified by
      this UId
      [Stored, Weak, Tied] StoredObject TargetObject;
      // namespace is a UId which identifies the namespace in which Id
is guaranteed to be unique.
      [Stored] UId namespace;
      // Id is the unique identifier for TargetObject among all the objects
identified by IdProvider.
      [Stored] String Id;
      }
```

Where Clauses

Abstract Class WhereClause

This is the root class for all WhereClause types.

Class AllWhere

Restricts the results to only those items that satisfy all of the subordinate WhereClauses. For example:

```
class AllWhere : WhereClause
      {
      WhereClause clauses[ ];
      }
```

Class Any Where

Restricts the results to only those items that satisfy any of the subordinate WnereCclauses. For example:

```
Class AnyWhere : WhereClause
      {
      WhereClause clauses[ ];
      }
```

Class WhereFields

Restricts the results to only those items where the specified field compares in the specified way to the specified value. For example:

```
class WhereFieldIs : WhereClause
      {
      String fieldName;
      CompareType CompareType;
      Object Value;
      }
```

Class WhereFieldContainsKeyword

Restricts the results to only those items where the specified field contains the specified keywords in the same order. For example:

```
class WhereFieldContainsKeyword : WhereClause
      {
      String fieldName;
      String [ ] keywords;
      }
```

Class WhereFieldIsInRange

Restricts the results to only those items where the specified field has a value within the specified range. RangeType indicates whether or not to include the boundaries in the range. For example:

```
class WhereFieldIsInRange : WhereClause
    {
    String fieldName;
    Object MinValue;
    Object MaxValue;
    RangeType RangeType;
    }
class WhereKeyIsInRange : WhereClause
    {
    StoredObjectKey MinKey;
    StoredObjectKey MaxKey;
    RangeType RangeType;
    }
```

Class WhereFieldisAny

Restricts the results to only those items where the value of the specified field is found in the specified collection. For example:

```
class WhereFieldIsAny : WhereClause
    {
    String fieldName;
    StoredObjects StoredObjects;
    }
```

Data Security

Any StoredObject can have any number of FieldRestrictions associated with it. If there are no FieldRestrictions, then none of the fields are restricted. If there are any FieldRestrictions, the credentials specified on the ObjectStore are used to authenticate the field access rights. If there are any FieldRestrictions, then all fields are restricted, unless a specific FieldRight is granted. The FieldRights property of the FieldRestriction returns an empty set until the right credential has been presented.

Note: in some implementations, a data provider may specify the same FieldRestriction for all the data it provides, so the authentication would occur only on the first access of an object with that restriction. In such implementations, subsequent accesses to objects with the same FieldRestriction need not be re-authenticated.

Class FieldRestriction StoredObject
Properties
FieldRights FieldRights
   Methods
Boolean Authenticate(Credential credential)

Class FieldRight StoredObject
Properties
String FieldName
Boolean Read
Boolean Write

Class Credential
Properties
TBD
   Primary Guide Objects

These objects 116 can populate parts of the EPG. For any class derived from StoredObject, there is a corresponding collection class derived from StoredObjects.

Class Program: StoredObject
Illustrative Properties
String Title
String Description
String Seriesid
String EpisodeTitle
String Episodeld
String Language
Int32 Year
DateTime OriginalAirDate
Boolean lsepisodic
Ratings Ratings
Genres Genres
Attrs Attrs
Credits Credits

Class Service : StoredObject
Illustrative Properties
String Name
String CallSign
String Affiliation
String Description
Int32 PreferedNumber
Boolean IsPayPerView
Attrs Attrs

Class Channel: StoredObject
Illustrative Properties
ChannelLineup ChannelLineup {get;}
Service Service
Int32 Number
Int32 Order
DateTime StartTime
DateTime EndTime
Boolean Blocked

Class ChannelLineup StoredObject
Properties

String Name

Channels Channels

Class ScheduleEntry StoredObject
Properties
Service Service
Program Program
DateTime StartTime
DateTime EndTime
Attrs Attrs
   Secondary Guide Objects

In some implementations, these objects may play a supportive role for the primary guide objects.

Class A ttr: StoredObject
Properties
String System
String Type
String Value

Class Rating StoredObject
Properties
String System
String Name
Int32 Value

Note: Ratings can have UIds so that they can be positively identified.

Class Genre. StoredObject
Properties
String System
String Name
Genre Left
Genre Right
String Label

Class TuneRequest: StoredObject
Properties
Service Service
Locator Locator
Byte [ ] TuneRequestBytes

Class Locator: StoredObject
Properties
Int32 SignalQuality
Byte [ ] LocatorBytes
   Downloading and Loading Guide Data

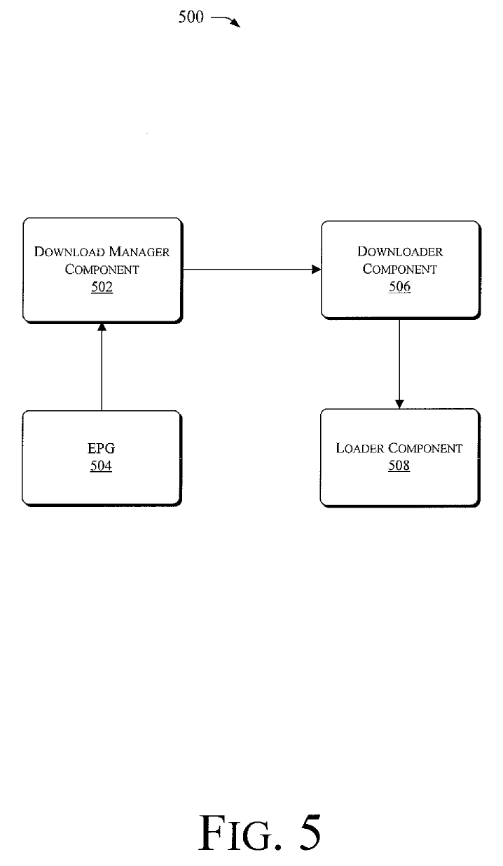

FIG. 5 illustrates an operating environment 500 containing components with which the applications 108 may operate. Various ones of these components are now described.

Download Manager Component

A download manager component 502 uses information stored in the EPG (referenced as 504) to launch an appropriate downloader component 506 at the appropriate time. For example, at 600 pm on a given day, the EPG 504 may direct the download manager component 502 to download data for programming schedule for the 800 pm-900 pm time slot across all available channels.

When the downloader component 506 completes successfully, it launches an appropriate guide loader component 508. The download manager component 502 can establish an internet connection prior to launching the downloader components 506. The download manager component 502 is launched at scheduled intervals using, for example, a scheduler built-in to an operating system under which the operating environment 500 runs. An example of such an operating system is the WINDOWS( family of operating systems available from Microsoft. The download manager component 502 can also be launched on demand by an application 108 (e.g. during a first run to force an initial download).

Downloader Components

Downloader components 506 fetch data from a specified location, and deliver it to a specified location. The downloader components 506 can, for example, take the form of a downloader provided by the content providing service 204 (e.g., WMIS). In other implementations, the downloader components 506 can perform an HTTP Get of the desired file

Loaders

Loader components 508 take data from a specified location and store it in the specified location, They fire events that indicate the progress and status of a given load.

Having described various components of the operating environment 100, the description now turns to a metadata exchange format (MXF) suitable for implementing the data flow 110 shown in FIG. 1 and for transferring the objects 116 shown in FIG. 3.

Metadata Exchange Format (MXF)

In some implementations, a Metadata Exchange Format (MXF) as described herein specifies a data interchange format used when delivering data 110 into an Object Store 114. The MXF can be used for all data 110 that is delivered to and/or from the client systems 102, and to and/or from the object store 114. The Object Store 114 is the repository of the data used to populate, for example, the EPG 504. The types of objects 116 that can be stored in the Object Store 114 are extensible. Accordingly, the MXF can also be extensible.

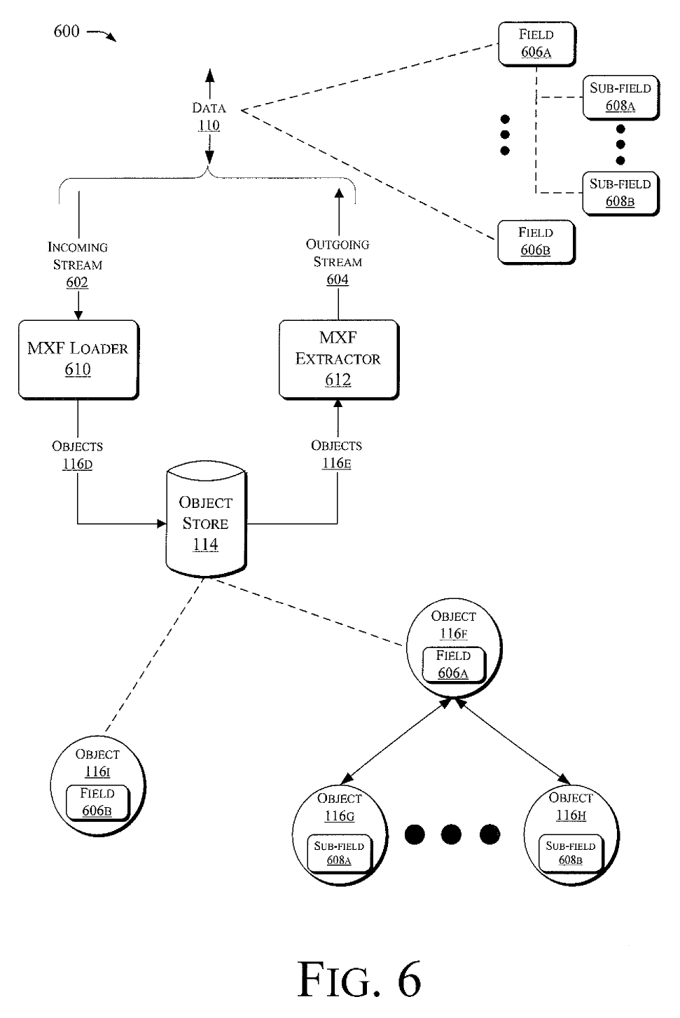

FIG. 6 illustrates the data flow 110 as shown in FIG. 1, broken into a stream 602 incoming to the object store 114 and a stream 604 outgoing from the object store 114, along with related processing components. The data flow 110 as shown in FIG. 6 can be considered to be any of the data flows 110 shown in FIG. 1.

For convenience, but not limitation, the data 110 is assumed to have the general structure shown in FIG. 6. More particularly, the data 110 may include one or more fields or elements 606, two of which are shown as 606a and 606b. The fields or elements 606 may include one or more respective sub-fields or sub-elements 608, two of which are shown as 608a and 608b. While FIG. 6 shows two instances of the fields or elements 606 and of the sub-fields or sub-elements 608, it is understood that implementations of the foregoing could include any number of such fields or elements 606, or of such sub-fields or sub-elements 608. Additionally, it is noted that the sub-fields or sub-elements 608 could, in turn, include further sub-fields or sub-elements, as appropriate for representing data 110 having virtually any structure. The fields 606 and/or the sub-fields 608 can be considered as class definitions for various instances of the data 110, or for objects representing such data 110.

Without loss of generality, and only for ease of discussion, assume for example that the fields 606a and 606b correspond to some aspect of two upcoming programs, and that the respective sub-fields 608a and 608b for the fields 606a and 606b specify parameters relating to these upcoming programs. For example, the fields 606a and 606b may correspond to respective episodes of a TV series. In turn, the sub-fields or sub-elements 608a and 608b may specify data specific to the different episodes, such as an episode synopsis, one or more guest stars appearing in the episode, or the like. The discussion below elaborates further on this example as appropriate.

The MXE can be expressed, for example, in XML. Assuming an XML implementation, an MXF Loader 610 receives the incoming stream 602 of XML data 110, and updates the Object Store 114 with objects 116d that correspond to the data 110 contained in the incoming MXF stream 602. Put differently, the MXF Loader 610 can load the objects 116 into a persistent store 114 at least in part by mapping the class definitions of the objects 116 to corresponding fields defined within the store 114.

An MXF Extractor 612 serializes a set of objects 116e from the Object Store 114 into the outgoing MXF stream 604. Put differently, the MXF MXF Extractor 612 can extract the objects 116 from a persistent store 114 at least in part by representing the objects 116 in an interchange format, such as MXF. The MXF Extractor 612 can also map the class definitions of the objects 116 to corresponding fields of the interchange format, and formulate these objects into the MXF stream 604. That MXF stream 604 can then be delivered to, for example, another client system 102, and used as input to another MXF Loader 610 at that client system 102.

Architecture

Representation of objects in MXF.

MXF may be viewed as an XML expression of objects 116 that are en route to or from an object store 114. Recall that instances of the object store 114 may be repeated with the ObjectStore object described above. Objects in the ObjectStore can derive from the abstract base class StoredObject. An object 116 from the ObjectStore can be represented in MXF as an XML element having the same name as the type of the object 116. The fields of the object 116 as represented in the MXF can be expressed as attributes or child elements of the object 116 as represented in the object store 114. Typically, but not exclusively, an attribute can be used if the field value is short. In either case, the name of the field is used for the name of the attribute or child element. If there is no attribute or child element specified for a field, then the field is unaffected (i.e., it won't be changed from whatever value it had when it was created or last saved). Attributes and child elements that do not correspond to fields in the object can be ignored for forward compatibility.

In addition, objects 116 can be instantiated and stored in the object store 114 in relationships corresponding to the structure of the fields 606 and/or sub-fields 608 discussed above. Thus, an object 116f may be instantiated to correspond to the field 606a, an object 116g may be instantiated to correspond to the sub-field 608a, and an object 116h may be instantiated to correspond to the sub-field 608b. Any features, elements, attributes, or the like that pertain to the field 606a are represented in the objects 116f, 116g, and/or 116h. Additionally, an object 116i may be instantiated to correspond to the field 606b.

When processing incoming data 602 into the object store 114, the MXF loader 610 may map the fields 606 and sub-fields 608 to corresponding objects 116, (e.g., objects 116f, 116g, and 116h). Additionally, the MXF loader 610 may map the field 606b to an object 116i.

When processing outgoing data 604 from the object store 114, the MXF extractor 612 may perform the opposite: it may map the objects 116, (e.g., objects 116f, 116g, and 116h) to corresponding fields 606 and sub-fields 608. Additionally, the MXF loader 610 may map the object 116i to a field 606b.

Returning to the above example, and briefly returning to FIG. 3, the core component 304 may access the objects 116f, 116g, and 116h from the object store 114, and pass them to the guide platform application 108a. The guide platform application 108a, in turn, may use these objects 116f, 116g, and 116h to populate fields of the EPG, and to present the EPG to the user 120 via the user interface 302. Thus, the EPG could present information relating to the two upcoming episodes, and could also present information relating to the episode synopsis, one or more guest stars appearing in the episode, or any other data contained in the object store 114.

It is noted that the order of attributes and child elements is irrelevant; they can be specified in any order. Example 1 illustrates how fields can be specified as either child elements or as attributes.

### EXAMPLE 1

### Fields Specified as Child Elements and as Attributes

```
class Person : StoredObject
    {
    [Stored] String firstName;
    [Stored] String lastName;
    }
<Person>
    <firstName>John</firstName>
    <lastName>Doe</lastName>
</Person>
<Person firstName=”Jane” lastName=”Doe”/>
```

Reference Fields

If an object 116 in the MXF is referenced by another object 116 (see, e.g., objects 116a and 116b in FIG. 4), the element includes an id attribute with a value that is unique within the MXF, This id value is used to refer to the object 116 within the MXF. When an object 116 has a reference field, that reference field can be specified as an attribute whose value corresponds to the id of the object 116 that it is referencing. As an alternative, the reference field can be specified as a child element that fully expresses an instance of the referenced type. As still another alternative, the reference field can be specified as a child element that simply refers to the other object 116 using the idref attribute.

If an inline instance is specified, it can still be referenced by other objects 116 as long as it specifies a unique id value, as shown by Example 2 below:

### EXAMPLE 2

```
class Person : StoredObject
    {
    [Stored] String firstName;
    [Stored] String lastName;
    [Stored] Person mother;
    [Stored] Person father;
    }
<Person id=“John Doe Jr” firstName=“John” lastName=“Doe”>
    <father firstName=“John” lastName=“Doe”/>
</Person>
<Person id=“Jane Doe” firstName=“Jane” lastName=“Doe”>
</Person>
<Person id=”Billy Doe” firstName=“Billy” lastName=“Doe”
mother=“Jane Doe”>
    <father idref=“John Doe Jr”/>
</Person>
```

Grouping to Share Common Values

Objects 116 may be grouped to share common data by enclosing them in a group element. Items of the same base class can be grouped. The group element's name is the plural form of the items it contains (e.g., Program→Programs, Person+People). The attributes specified on the group element are inherited by the child elements (i.e., if the child element doesn't specify a value for a field, the value specified for the group will be used). Example 3 illustrates grouping with a common attribute:

### EXAMPLE 3

### Grouping with Common Attribute

```
<People lastName=“Doe”>
    <Person id=“John Doe Jr” firstName=“John”>
        <father firstName=“John” lastName=“Doe”/>
    </Person>
    <Person id=“Jane Doe” firstName=“Jane”/>
    <Person id=”Billy Doe” firstName=“Billy” mother=“Jane Doe”>
        <father idref=“John Doe Jr”/>
    </Person>
</People>
```

Array Fields—Value Types

Arrays fields can be specified as, for example, a list whose elements are comma-separated or otherwise delimited from one another. For string fields, the values can be quoted if they contain spaces or commas, shown in Example 4 below:

### EXAMPLE 4

### Array Fields—Value Types

```
class Person : StoredObject
    {
    [Stored] String firstName;
    [Stored] String lastName;
    [Stored] String [ ] honors;
    [Stored] Int32 [ ] favoriteIntegers;
    [Stored] Person mother;
    [Stored] Person father;
    }
<Person id=“Sir Winston Churchill” firstName=“Winston”
        lastName=“Churchill” honors=”OM., KG.,CH., PC”>
    <favoriteIntegers>337, 1874, 0, 42</favoriteIntegers>
</Person>
```

Array Fields—Reference Types

Arrays of references are specified as child elements of an element that has the same name as the field. The child elements are named the same as the referenced type, as shown in Example 5:

### EXAMPLE 5

```
class Person : StoredObject
    {
    [Stored] String firstName;
    [Stored] String lastName;
    [Stored] String [ ] honors;
    [Stored] Int32 [ ] favoriteIntegers;
    [Stored] Person mother;
    [Stored] Person father;
    [Stored] Animals pets;
    [Stored] Animals favoriteMeats;
    }
<Person id=“Paris Hilton” firstName=“Paris” lastName=“Hilton”>
    <pets>
        <Animal name=“Tinkerbell” species=“Canis canis”
        breed=“Chihuahua”/>
    </pets>
    <favoriteMeats>
        <Animal idref=“cow”/>
        <Animal idref=“pig”/>
    </favoriteMeats>
</Person>
```

Declaring Object Type Information

Type information can be specified for all types of objects 116 used in the MXF. The “Assembly” element and its attributes correspond to the NET type “AssemblyName”. The “NameSpace” element is used to group types that are part of the same namespace. The “Type” element provides the details that correlate the type in the assembly to the elements in the MXF.

Assembly Element

| Attribute | Description |
|---|---|
| name | name of the assembly |
| version | major.minor[.build[.revision]] |
| cultureInfo | RFC 1766 standard format culture name or |
| | “neutral”. |
| | Default=“neutral”. |
| publicKeyToken | Default=“” |
| Child Elements | NameSpace, Type |

<Assembly name=“mcstore.dll” version=“1.0.0.0” publicKeyToken=
“365143bb27e7ac8b”>
</Assembly>

NameSpace Element

| Attribute | Description |
|---|---|
| Name | The name of the name space. Used to generate the |
| | FullName of enclosed Types. |
| Child | Type |
| Elements | |

<NameSpace name=“Microsoft.MediaCenter.Store”>
</NameSpace>

Type Element

| Attribute | Description |
|---|---|
| name | The name used for as the element name for |
| | objects of this type in this MFX file. |
| fullName | The fully qualified |
| | Default = NameSpace.Name + “.” + Name. |
| groupName | The name |
| | Default = Name + “s”. |
| parentFieldName | The name of the field in this type that refers |
| | to the enclosing object when an element of this type |
| | is specified as a child of another object. |
| | Default=“” |
| Child Elements | None |

<Type name=“ScheduleEntry” fullName=
“Microsoft.MediaCenter.Guide.ScheduleEntry”
groupName=“ScheduleEntries” parentFieldName=“service”/>

### EXAMPLE 6

```
<Assembly name=“mcstore.dll” version=“6.0.5045.0”>
    <namespace name=“Microsoft.MediaCenter.Store”>
        <Type name=“StoredObject”/>
        <Type name=“Provider”/>
        <Type name=“FieldRestriction”/>
        <Type name=“UID” parentFieldName=“target”/>
    </namespace>
</Assembly>
<Assembly name=“mcepg.dll” version=“6.0.5045.0”>
    <namespace name=“Microsoft.MediaCenter.Guide”>
        <Type name=“Program”/>
        <Type name=“ScheduleEntry” groupName=“ScheduleEntries”/>
    </namespace>
</Assembly>
```

Updating and Linking to Existing Data

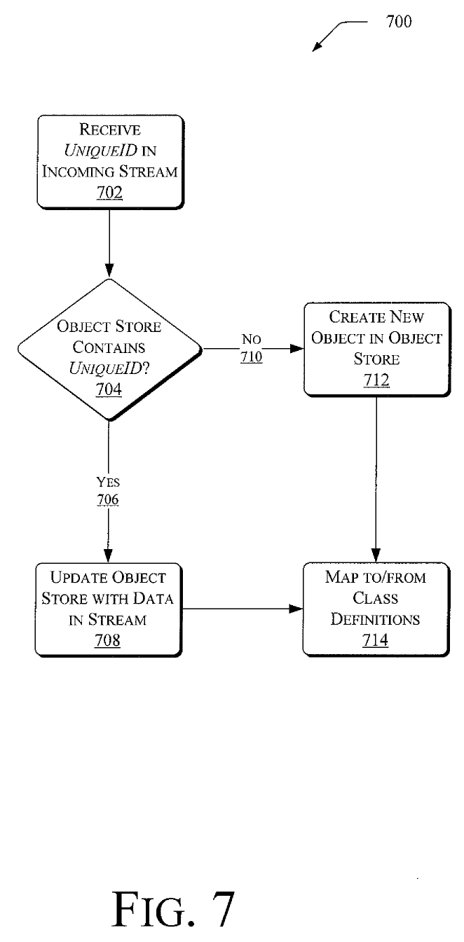

FIG. 7 illustrates a process flow 700 for correlating data in the incoming MXF stream 602 with objects 116 that already exist in the object store 114. For convenience, the process flow 700 is described herein in connection with the MXF loader 610 shown in FIG. 6 in but one possible implementation. However, it is understood that the process flow 700 may be performed by other components without departing from the spirit and scope of the subject matter described herein.

An element, such as the UId element illustrated below, is used to specify an id that is universally unique. In block 702, the MXF loader 610 encounters a UId element in the incoming MXF stream 602. Block 704 represents determining whether the object store 114 contains the UId element. If so, an object 116 having that UJd element already exists in the object store 114. In this case, the process flow 700 takes a Yes branch 706 to block 708. In block 708, the MXF loader 610 updates the object 116 that already exists in the object store 114.

Returning to block 704, if the object store 114 does not contain the UId element, this indicates that no object 116 in the object store 114 is associated with the UId element. In this case, the process flow 700 takes a No branch 710 to block 712. In block 712, the MXF loader 610 creates a new object 116 associated with the Ufd element, and updates this new object 116 as appropriate.

After performing one of blocks 712 or 708, the process flow 700 proceeds to block 714. In block 714, data is mapped to/from the class definitions of the object 116, depending on whether data is being added to or extracted from the store 114.

In any of the above cases, any fields that are not present in the incoming MXF stream 602 are left unchanged by the update. The UId element is shown in the table below:

UId Element

| Attribute | Description |
|---|---|
| target | idref to the element for which this id is unique. |
| | Note: When the UId element is a child of another object, |
| | this defaults to the containing element. |
| namespace | A UId which uniquely identifies the name space for this |
| | id. |
| idValue | The unique identifier for this object within the specified |
| | name space. |
| Child | None |
| Elements | |

<UId target=“foo” namespace=“WMIS.ProgramIds” value=“P1234”/>

Describing the attributes of the UId element in turn, the idValue attribute may contain, for example, a string representing the unique identifier itself. The namespace attribute indicates a context in which the idValue attribute is unique. The target attribute points to an element to which the idValue attribute corresponds.

As an example of the foregoing, consider an identification scheme employed in the context of U.S. Social Security numbers. Assume that a person named John Smith has a Social Security number of 123-45-6789. If John Smith were to be represented using the above UId element, the Id attribute would be assigned the string “123-45-6789”, the target attribute would point to the string “John Smith”, and the namespace attribute would contain information indicating that the string “123-45-6789” is unique in the context of numbers assigned by the United States Social Security Administration.

The UId element enables the various operating environments shown herein to perform extensibly, so as to handle data 110 having any format or structure, without relying on a rigid specification to define such formats or structure. For example, assume that the fields 606a and the subfields 608a and 608b shown in FIG. 6 each are assigned respective UId elements. If the incoming stream 602 includes each of these three UId elements, the process flow 700 shown in FIG. 7 is performed on each of these UId elements. When a given UId element already appears in the object store 114, the process flow updates the object store 114 with the data from the incoming stream 602. Otherwise, a new entry in the object store 114 is created, and is associated with the given UId element.

As an example of the foregoing, assume that the field 606a contains data for a given episode of a TV series, and is associated with a given UId element. If this UId element is already in the object store 114, then the field 606a contains data used to update the object store 114 with new data for the given episode. Otherwise, a new entry is made in the object store 114 for the given episode.

Assume further that the sub-field 608a provides an episode synopsis for the given episode, and that the sub-field 608b lists any guest stars appearing in the given episode. Assume also that the sub-field 608a and the sub-field 608b are associated with respective UId elements. If the UId element for the sub-field 608a already exits in the object store 114, then the object store 114 is updated with a new episode synopsis. Otherwise, a new entry for the episode synopsis is created in the object store 114. Similarly for the list of guest stars, if the UId element for the sub-field 608b already exits in the object store 114, then the object store 114 is updated with a new list of guest stars. Otherwise, a new entry for the list of guest stars is created in the object store 114.

The UId element can be specified either as a child of another object 116 or not. If UId element is not a child, then the target attribute is specified. Otherwise, the target defaults to point to the containing object. Example 7 below illustrates the UId element as a child, and not as a child.

### EXAMPLE 7

### UId as Child and not as Child

```
<UId target=“P1234” nameSpace=“Microsoft.MediaCenter.ProgramIds”
value=“P1234”/>
<Program id=“P1234” title=“Curb your Enthusiasm”/>
<Program id=“P2468”>
    <UId namespace=“Microsoft.MediaCenter.ProgramIds”
    value=“P2468”/>
</Program>
```

Delivering Files with the MXF

Additional data files can be specified in the MXF using the “Attachment” object. This specifies the URL for the additional file along with metadata about the file. In but one implementation, this metadata can include a decryption key. The Download Manager 502 (see FIG. 5) can fetch the file to a temporary directory, and process it according to the file type. If the file contains MXF, then it is loaded using the MXF loader 610. If it is a cab file, it is exploded into the temporary directory, and each of the individual files are processed appropriately (e.g., MXF files loaded, install scripts run). Example 8 illustrates this process below:

### EXAMPLE 8

```
class Package : StoredObject
    {
    [Stored] String name;
    }
class Attachment : StoredObject
    {
    [Stored] Package package;
    [Stored] String url;
    [Stored] String key;
    }
<Assembly name=“mcstore.dll” Version=“6.0.5045.0”>
    <nameSpace=“Microsoft.MediaCenter.Store”>
        <Type name=“Package”/>
        <Type name=“Attachment” parentFieldName=“package”/>
    </namespace>
</Assembly>
<Package name=”Sports data”>
    <Attachment url=”EXAMPLE_URL/Sports/Part1” key=”1234”/>
    <Attachment url=”EXAMPLE_URL/Part2”/>
</Package>
```

Putting it all Together

Example 9 below provides an example applying several of the foregoing concepts.

### EXAMPLE 9

```
<MXF version=“1.0”>
  <Assembly name=“mcstore.dll” Version=“6.0.5045.0”>
    <nameSpace=“Microsoft.MediaCenter.Store”>
      <Type name=“StoredObject”/>
      <Type name=“Provider”/>
      <Type name=“FieldRestriction”/>
      <Type name=“UId” parentFieldName=”target”/>
    </namespace>
  </Assembly>
  <Assembly name=“mcepg.dll” Version=“6.0.5045.0”>
    <nameSpace=“Microsoft.MediaCenter.Guide”>
      <Type name=“Service”/>
      <Type name=“TuneRequest”/>
      <Type name=“ATSCTuneRequest”/>
      <Type name=“Channel”/>
      <Type name=“ChannelLineup”/>
      <Type name=“Program”/>
      <Type name=“ScheduleEntry” groupName=“ScheduleEntries”/>
    </namespace>
  </Assembly>
  <Provider id=“WMIS”>
    <UId nemeSpace=“Microsoft.MediaCenter.ProviderNames”
  idValue=“WMIS”/>
  </Provider>
  <StoredObjects provider=“WMIS”>
    </TuneRequests>
      <ATSCTuneRequest id=”tr4.1” phys=”38” major=”4”
      minor=”1”/>
      <ATSCTuneRequest id=”tr5.1” phys=”48” major=”5”
      minor=”1”/>
      <ATSCTuneRequest id=”tr7.1” phys=”39” major=”7”
      minor=”1”/>
    </TuneRequeets>
    <Services>
      <Service id=”KOMO-DT” name=”KOMO-DT”
      callSign=“KOMO-DT“ affiliation=”CBS” tuneRequest=”tr4.1”/>
      <Service id=”KING-DT” name=”KING-DT”
      callSign=“KING-DT“ affiliation=”NBC” tuneRequest=”tr5.1”/>
      <Service id=”KIRO-DT” name=”KIRO-DT” callSign=“KIRO-DT“
      affiliation=”ABC” tuneRequest=”tr7.1”/>
    </Services>
    <ChannelLineup name=”ATSC - 98052”>
      <Channels>
        <Channel name=”1041” service=”KOMO-DT”/>
        <Channel name=”1051” service=”KING-DT”/>
        <Channel name=”1071” service=”KIRO-DT”/>
      </Channels>
    </ChannelLineup>
    <Services>
      <Service id=”KOMO-DT” name=”KOMO-DT”
      callSign=“KOMO-DT“ affiliation=”CBS” tuneRequest=”tr4.1”/>
      <Service id=”KING-DT” name=”KING-DT”
      callSign=“KING-DT“ affiliation=”NBC” tuneRequest=”tr5.1”/>
      <Service id=”KIRO-DT” name=”KIRO-DT” callSign=“KIRO-DT“
      affiliation=”ABC” tuneRequest=”tr7.1”/>
    </Services>
    <Programs>
      <Program id=”p1” title=”Lost” episodeTitle=”Weird Stuff
      Happens”>
        <UId namespace=”WMIS.ProgramIds” idValue=”1234”>
        <Description>
        example description.
        </Description>
      </Program>
    </Programs>
    <ScheduleEntries service=”KOMO-DT”>
      <ScheduleEntry program=”p10”/>
      <ScheduleEntry program=”p11”/>
    </ScheduleEntries>
    <ScheduleEntries service=”KING-DT” >
      <ScheduleEntry program=”p20” startTime=”xxx”
      endTime=”xxx”/>
      <ScheduleEntry program=”p21”startTime=”xxx”
      endTime=”xxx”/>
    </ScheduleEntries>
    <ScheduleEntries service=”KING-DT”>
      <ScheduleEntry program=”p20” startTime=”xxx”
      endTime=”xxx”/>
      <ScheduleEntry program=”p21” startTime=”xxx”
      endTime=”xxx”/>
    </ScheduleEntries>
    <ScheduleEntries service=”KIRO-DT”>
      <ScheduleEntry program=”p30” startTime=”xxx”
      endTime=”xxx”/>
      <ScheduleEntry program=”p31” startTime=”xxx”
      endTime=”xxx”/>
    </ScheduleEntries>
  </StoredObjects>
</MXF>
```

### CONCLUSION

Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

In addition, regarding certain flow diagrams described and illustrated herein, it is noted that the processes and sub-processes depicted therein may be performed in orders other than those illustrated without departing from the spirit and scope of the description herein.

1. A method comprising:
receiving a plurality of objects having respective class definitions; and
loading the objects into a persistent store at least in part by mapping the class definitions of the objects to corresponding fields of the store.

2. The method of claim 1, wherein the receiving a plurality of objects includes receiving the objects from a data source, and wherein the data source includes at least one of a client system, a content providing service, and a cable or satellite television service.

3. The method of claim 1, further comprising populating an electronic program guide (EPG) using, at least in part, the objects.

4. The method of claim 1, further comprising presenting an electronic program guide (EPG) to a user, wherein the BPG is populated using, at least in part, the objects.

5. The method of claim 1, further comprising performing a garbage collection operation on the store.

6. The method of claim 5, wherein performing the garbage collection operation includes determining whether at least one of the objects is referenced by another object.

7. The method of claim 5, wherein performing the garbage collection operation includes determining whether at least one of the objects is locked against deletion.

8. The method of claim 1, further comprising receiving respective unique identifier elements associated with the objects, and further comprising determining whether the store already contains instances of the unique identifier elements.

9. The method of claim 8, further comprising updating at least one existing object in the store, wherein the object has a unique identifier element matching at least one of the received unique identifier elements.

10. The method of claim 8, further comprising creating at least one object in the store, wherein the new object has a unique identifier element matching at least one of the received unique identifier elements.

11. A method comprising:
receiving a plurality of objects having respective class definitions; and
representing the objects in an interchange format by mapping the class definitions of the objects to corresponding fields of the interchange format.

12. The method of claim 1 1, wherein receiving the objects includes extracting the objects from a persistent store.

13. The method of claim 11, further comprising serializing the objects for representation in the interchange format.

14. The method of claim 11, further comprising transmitting the objects in the interchange format from a first client system to at least a second client system, and further comprising specifying at least one data file in the interchange format using an attachment object.

15. The method of claim 11, further comprising populating an electronic program guide (EPG) using, at least in part, the objects, and wherein the objects are transmitted in the interchange format from a first client system to at least a second client system.

16. The method of claim 11, further comprising presenting an electronic program guide (EPG) to a user, wherein the EPG is populated using, at least in part, the objects, and wherein the objects are transmitted in the interchange format from a first client system to at least a second client system.

17. A data structure for representing a unique identifier element in an object store, the data structure comprising:
an idValue field for containing a unique identifier;
a namespace field for containing data indicating a context in which the identifier contained in the value field is unique; and
a target field for pointing to an element for which the identifier contained in the value field is unique.

18. A process using the data structure of claim 17 to map objects represented in an interchange format into a persistent store.

19. A process using the data structure of claim 17 to update an existing object in a persistent store.

20. A process using the data structure of claim 17 to create a new object in a persistent store.
